(19) United States
(12) Patent Application Publication
(10) Pub. No.: US 2008/0163527 A1
(43) Pub. Date: Jul. 10, 2008

(54) Fashion talk sticker

(76) Inventor: Moustafa Ahmed, Villanova, PA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/651,696

(22) Filed: Jan. 9, 2007

(51) Int. Cl. G09F 11/00

(52) U.S. Cl. 40/601

(57) ABSTRACT

The fashion talk sticker is a new, cool way to convey a message to anyone around. The sticker consists of a message pocket with a title. The pocket has a slit that conceals a customized message tab. Attached to the message tab is a cord with a miniature ornament. The ornament can be placed inside or outside the message pocket. You pull the cord and the message appears. T-shirts manufactured with fashion talk sticker can be very useful for children at public places. The sticker can carry contact information of a child such as name, address and phone number of parents. You also can put the sticker anywhere else, even on accessories such as handbags or backpacks.

### FIELD OF THE PRESENT INVENTION

Means for a sticker consisting of a message pocket with a title. The pocket has a slit which conceals a customized message tab. Attached to the message tab is a cord with a miniature ornament. The ornament can be placed inside or outside the message pocket. A message tab can be concealed in its pocket. The ornament and the cord can be concealed as well or exposed.

### BACKGROUND OF THE PRESENT INVENTION

At camps, parties, conferences, trade fairs, or any event, the fashion talk sticker is a new, cool way to convey a message to anyone around. T-shirts manufactured with the fashion talk sticker can be very useful for children at public places. The fashion talk stickers can carry contact information of a child such as name, address, phone number and name of parents. In the same way, it can be used for adults at camps, parties, conferences, trade fairs or any event. The fashion talk sticker also can be manufactured with clothing such as T-shirts as an advertisement for companies. An example is a company logo or Web site. Also, one can put the fashion talk sticker anywhere else, even on accessories such as handbags or backpacks.

The fashion talk sticker is a means of carrying identification information. It can be used at camps, parties, conferences, trade fairs or any event. The fashion talk sticker is a new, cool way to convey a message to anyone around. Fashion talk stickers may come blank so customers can write any message or title using a special pen or a special alphabetic letters sticker.

### SUMMARY OF THE PRESENT INVENTION

The fashion talk sticker is a new, cool way to convey a message to anyone around. The sticker consists of a message pocket with a title. The pocket has a slit that conceals a customized message tab. Attached to the message tab is a cord with a miniature ornament. The ornament can be placed inside or outside the message pocket. You pull the cord and the message appears. T-shirts manufactured with fashion talk sticker can be very useful for children at public places. The sticker can carry contact information of a child such as name, address and phone number of parents. You also can put the sticker anywhere else, even on accessories such as handbags or backpacks.

### BRIEF DESCRIPTION OF THE PREFERRED EMBODIMENT

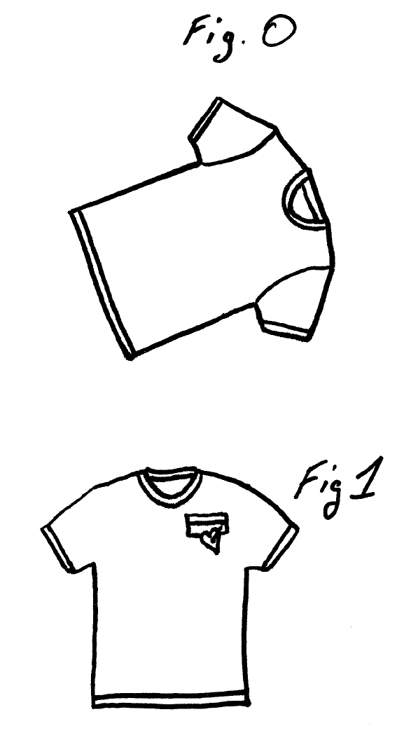

FIG. 0 is a generic piece of clothing.

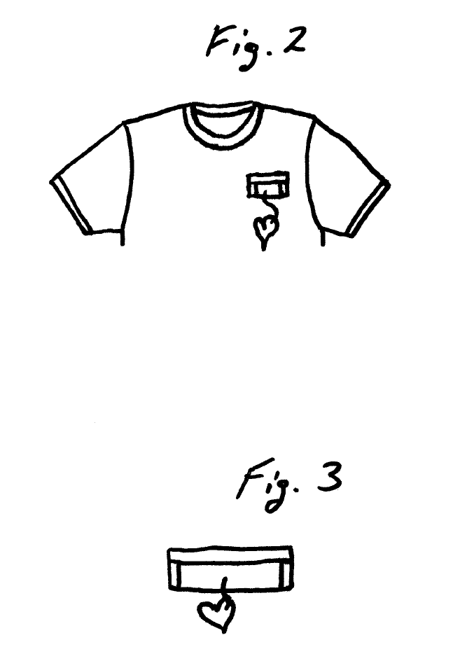

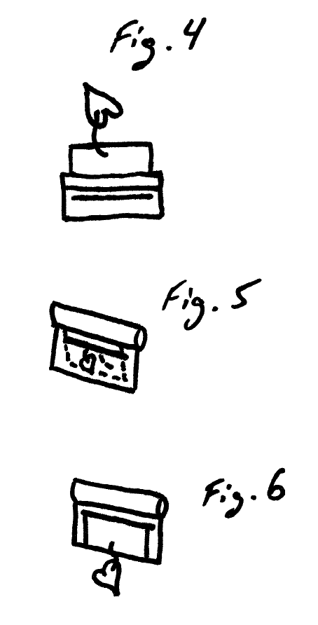

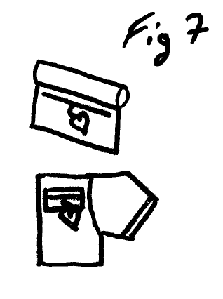

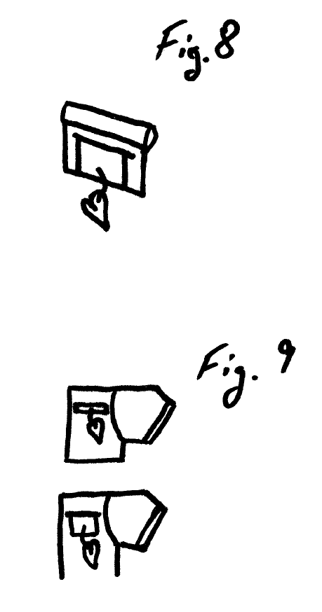

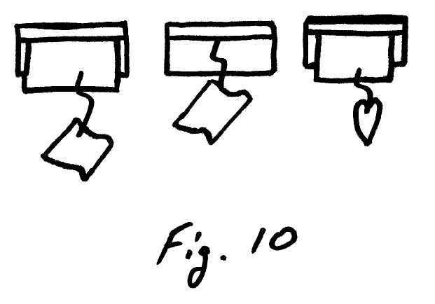

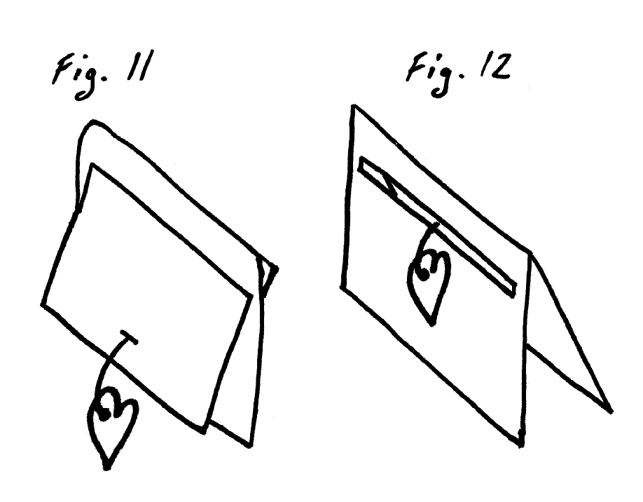

FIG. 1 shows how the fashion talk sticker looks after it is placed on the clothing.

FIG. 2 shows a customized miniature ornament and cord.

FIG. 3 shows a customized title with exposed message tab.

FIG. 4 shows the fashion talk sticker with a full view of the sticker.

FIG. 5 shows the fashion talk sticker with the message tab concealed inside the pocket.

FIG. 6 shows the fashion talk sticker after you pull the cord and the message appears.

FIG. 7 shows the fashion talk sticker in its original condition with the message tab re- concealed in its pocket.

FIG. 8 shows a blank fashion talk sticker in which customers can write any message or title using a special pen.

FIG. 9 shows a manufactured piece of clothing with built-in pocket and fashion talk sticker.

FIG. 10 shows an example of a customized fashion talk sticker.

FIG. 11 shows how you pull the cord and the message appears.

FIG. 12 shows the fashion talk sticker in its original condition with the message tab re-concealed in its pocket.

### DETAILED DESCRIPTION

The fashion talk sticker is a new, cool way to convey a message to anyone around. The sticker consists of a message pocket with a title. The pocket has a slit that conceals a customized message tab. Attached to the message tab is a cord with a miniature ornament. The ornament can be placed inside or outside the message pocket. You pull the cord and the message appears. T-shirts manufactured with fashion talk sticker can be very useful for children at public places. The sticker can carry contact information of a child such as name, address and phone number of parents. You also can put the sticker anywhere else, even on accessories such as handbags or backpacks.

In the original condition, the message tab is concealed in its pocket. The ornament and the cord can be concealed or exposed. You pull the cord and the message appears. The fashion talk sticker can be made with any kind of fabric, textile, material, cloth or paper. The fashion talk sticker may come blank so customers can write any message or title using a special pen or special alphabetic letters sticker. The sticker also may be manufactured with a customized printed message and title. Manufactured pieces of clothing such as T-shirts with built in pockets also work. The ornament can be designed as any logo and can be placed inside or outside the message pocket, or the pocket of a T-shirt.

Means for holding a sticker further providing a message tab that can be concealed in its pocket. The ornament can be concealed or exposed as well. Means of carrying identification information can be used at camps, parties, conferences, trade fairs or any event. T-shirts manufactured with fashion talk sticker can be very useful for children at public places. The sticker can carry contact information of a child such as name, address and phone number of parents. You also can put the sticker anywhere else, even on accessories such as handbags or backpacks. The means to manufacture T-shirts with the fashion talk sticker has a slit on the T-shirt which conceals a customized message tab. The ornament can be designed as any logo and can be placed inside or outside the message pocket.

It is a means of advertisement for companies. The fashion talk sticker also can be manufactured with clothing such as T-shirts as an advertisement for companies. An example is a company logo or Web site. Also, one can put the fashion talk sticker anywhere else, even on accessories such as handbags or backpacks.

The sticker consists of a message pocket with a title. The pocket has a slit which conceals a customized message tab. Attached to the message tab is a cord with a miniature ornament. The ornament can be placed inside or outside the message pocket. FIG. 0 shows a generic piece of clothing. FIG. 1 shows how the fashion talk sticker looks after it is placed on the clothing. This is the original condition. It has an ornament with cord attached to an open slit in which the message tab is concealed. FIG. 2 shows a customized miniature ornament and cord. FIG. 3 shows a customized title with exposed message tab. FIG. 4 shows the fashion talk sticker with a full view of the sticker. This includes message, title, pocket, message tab with cord and ornament. FIG. 5 shows the fashion talk sticker with the message tab concealed inside the pocket. FIG. 6 shows the fashion talk sticker after you pull the cord and the message appears. FIG. 7 shows the fashion talk sticker in its original condition with the message tab re-concealed in its pocket. FIG. 8 shows a blank fashion talk sticker in which customers can write any message or title using a special pen. FIG. 9 shows a manufactured piece of clothing with built-in pocket and fashion talk sticker. The fashion talk sticker may come blank so customers can write any message or title using a special pen or special alphabetic letters sticker. FIG. 10 shows an example of a customized fashion talk sticker. FIG. 10 shows when message is revealed, message is concealed and another example of “John” at a party. FIG. 11 shows how you pull the cord and the message appears. FIG. 12 shows the fashion talk sticker in its original condition with the message tab re-concealed in its pocket.

1-8. (canceled)

9. A message system, comprising:
attaching a cord to a message tab, the cord attached to an ornament;
placing the ornament outside a pocket;
concealing the message tab within the pocket;
writing a message; and
pulling the cord such that the message appears.

10. The message system of claim 9, further comprising concealing the message tab within a slit of the pocket.

11. The message system of claim 9, further comprising manufacturing T-shirts with a fashion talk sticker as an advertisement.

12. The message system of claim 9, further comprising providing the pocket with a title.

13. The message system of claim 9, further comprising carrying contact information on the message.

14. The message system of claim 9, further comprising carrying contact information on the message by a child.

15. The message system of claim 13, further comprising carrying contact information on the message by a child.

16. The message system of claim 13, further comprising carrying a name, an address and a phone number of parents.

17. The message system of claim 9, further comprising putting the sticker on a handbag.

18. The message system of claim 9, further comprising putting the sticker on a backpack.

19. The message system of claim 9, further comprising attaching the cord to a slit, the slit disposed in an open position.

20. The message system of claim 9, further comprising exposing the message tab with a customized title.

21. A message system, comprising:
attaching a cord to a message tab, the cord attached to an ornament;
placing the ornament outside a pocket;
concealing the message tab within the pocket;
writing a message;
pulling the cord such that the message appears;
further comprising concealing the message tab within a slit of the pocket;
further comprising manufacturing T-shirts with a fashion talk sticker as an advertisement;
further comprising providing the pocket with a title;
further comprising carrying contact information on the message;
further comprising carrying contact information on the message by a child;
further comprising carrying a name, an address and a phone number of parents;
further comprising putting the sticker on a handbag;
further comprising putting the sticker on a backpack;
further comprising attaching the cord to a slit, the slit disposed in an open position; and
further comprising exposing the message tab with a customized title.

22. A message system, comprising:
attaching a cord to a message tab, the cord configured to be attached to an ornament;
placing the ornament outside a pocket;
concealing the message tab within the pocket;
manufacturing the message tab with a customized printed message and title; and
pulling the cord such that the message appears.
